(19) United States
(12) Patent Application Publication
(10) Pub. No.: US 2024/0026790 A1
(43) Pub. Date: Jan. 25, 2024

(54) BLADE COMPONENT, METHOD FOR THE PRODUCTION THEREOF, AND GAS TURBINE

(71) Applicant: Rolls-Royce Deutschland Ltd & Co KG, Blankenfelde-Mahlow (DE)

(72) Inventors: Erik JANKE, Berlin (DE); Thomas SCHIESSL, Rangsdorf (DE); Ingolf LANGER, Quedlinburg (DE)

(21) Appl. No.: 18/266,193

(22) PCT Filed: Nov. 22, 2021
(86) PCT No.: PCT/EP2021/082529

§ 371 Date: Jun. 8, 2023

(30) Foreign Application Priority Data
Dec. 17, 2020 (DE) 10 2020 133 998.4

(51) Int. Cl. F01D 5/14

(52) U.S. Cl. CPC F01D 5/147; F05D 2230/22; F05D 2230/51; F05D 2260/20

(57) ABSTRACT

The invention relates to a blade component, a compressor or turbine stage of a gas turbine, in particular a gas turbine engine characterized in that the blade component includes at least two structural elements which can be connected together by means of a connection method, in particular sintering, and that the at least one connection face of the at least two structural elements lies on a face, wherein in particular the normal vector has, for at least a part of the face, a component perpendicular to the radial orientation of the blade component. The invention also concerns a method for manufacturing a blade component, and a gas turbine with a blade component.

The present disclosure relates to a blade component having the features of claim 1, a method for production of a blade component having the features of claim 9, and a gas turbine having the features of claim 13.

Blades in gas turbines, such as for example gas turbine engines, are components of complex form which are extremely complicated to manufacture. Also, in operation, the blades are exposed to particularly high thermal loads, so that the blades often comprise cooling devices on the inside. US 2009/0081032 A1 discloses such a blade of composite structure. US 2013/0052074 A1 describes a gas turbine component which can be manufactured by metal injection molding (MIM).

The object is to provide blade components which can be manufactured efficiently and in particular can be cooled in simple fashion.

According to a first aspect, such a blade component with the features of claim 1 is provided.

The blade component is designed for use in a compressor or turbine stage of a gas turbine, in particular of a gas turbine engine in an aircraft.

The blade component comprises at least two structural elements which can be connected together by means of a connection process, in particular sintering, wherein at least one connection face of the at least two structural elements lies on a face, the normal vector of which has, for at least a part of the face, a component to the radial orientation of the blade component.

The at least two structural elements may thus be used to form a blade component, wherein the structural elements touch one another at one or more points—the connecting face. The connecting face may thus be a closed face or consist of two or more parts, i.e. the structural elements then do not touch over the full face.

The one connecting face or the several connecting faces in particular lie on a spatial face which has a specific orientation. This face is at least partly oriented such that the respective normal vector lies in a face which is oriented perpendicularly to the radial orientation of the blade component.

One example of such a face is for example a plane which is arranged in the radial direction, i.e. it intersects the blade component vertically from top to bottom. Each normal vector of this plane thus lies in a plane oriented perpendicularly to the radial orientation of the blade component.

If the face is a plane which intersects the blade component at a certain slope to the radial direction thereof, then each normal vector of this plane has at least one component arranged perpendicularly to the radial orientation of the blade component.

More generally, the face in which the connecting face lies will be a curved face. It may be a regularly curved face, e.g. a parabolic face having an axis of curvature. It may however also be a free-form face which e.g. is undulating or in many regions has a different curvature.

Since the form of the face—and hence the spatial arrangement of the connecting face (one-piece or multipiece)—can be freely selected within broad limits, the blade component may be assembled from structural elements, the forms of which have been optimized. This face may e.g. pass through the skeletal lines of the blade component. The skeletal line is the connecting line of the centre point in a plane of a circle described in the profile of the blade component.

In one embodiment, at least one cooling duct, through which a cooling medium e.g. air can flow, is arranged in the interior of the blade component. Since blades are exposed to high thermal loads in particular in the high-pressure region of turbines, cooling is of great importance here. The shape of the cooling duct—and hence also the effect of the cooling—may be structured within broad limits thanks to the possible flexibility in the design of the structural elements. Thus the structural elements may be designed to form the cooling duct when assembled.

It is also possible that the at least two structural elements are designed as green parts of a metal injection molding process. The green parts may be designed and produced with corresponding shaping, and connected by sintering to form the blade components.

The at least two structural elements, in particular the at least two green parts, may be made of different materials or comprise different materials. Thus by choice of materials, mechanical and/or thermal loads can be taken into account. Thus e.g. the structural element comprising the stagnation point of the blade component may be constructed from a different metallic material from the component comprising the trailing edge of the blade component.

This applies not only to the blade components themselves but also to the integration of blade components into a blade ring inside the gas turbine. Thus the blade components as green parts can be connected to a ring component or a disc component, which is formed as a green part of a metal injection molding process, in particular by sintering, to form a compressor or turbine stage. This allows the ring component or disc component to be produced with a different process (e.g. 2D manufacturing, joining by sintering, friction or induction welding) from the complexly shaped blade components. After sintering, a blisk is obtained, i.e. a one-piece stage with a disc or ring body and blades connected thereto.

In one embodiment, one of the at least two structural elements comprises the suction side or the pressure side of the blade component. The connecting face (one piece or multipiece) in this case will have a substantially radial extent.

Because of the structure of the blade component, it is efficient to provide a cooling air opening which is formed in particular by the assembly of the at least two structural elements. Thus the cooling openings may be provided during production and need not be created afterwards, e.g. by boring.

The object is also achieved by a method having the features of claim 9.

The at least two structural elements may be connected, in particular sintered, to a ring component as a green part of a metal injection molding process, or to a disc component as a green part of a metal injection molding process.

Furthermore, the object is achieved by a gas turbine having the features of claim 11. It may be designed as a stationary gas turbine, as a gas turbine for a ship, or as a gas turbine engine for an aircraft.

In particular, the method may be configured as part of a metal injection molding process. Thus the blade component and/or at least one of the structural elements may also be produced by means of a lost core in the metal injection molding process. Thus complex shapes of the blade components or structural elements can be produced, in particular in the region of the foot.

In the drawing:

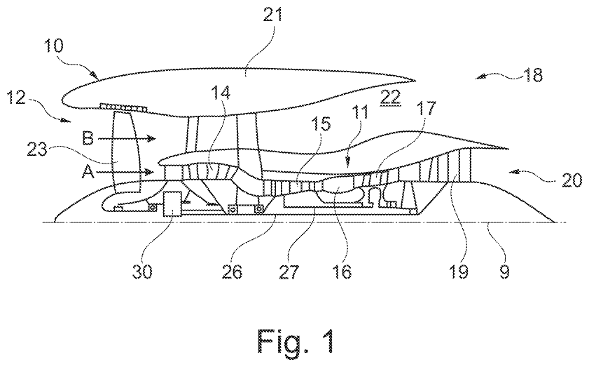

FIG. 1 shows a sectional side view of a gas turbine engine;

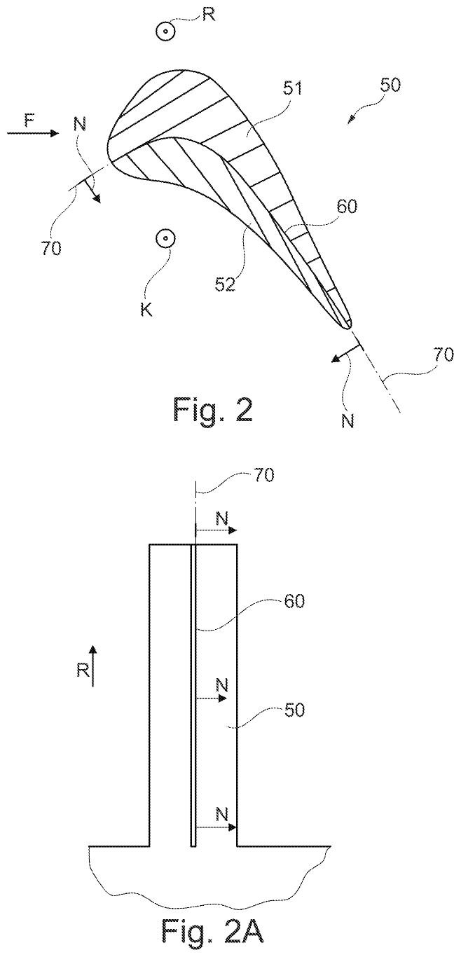

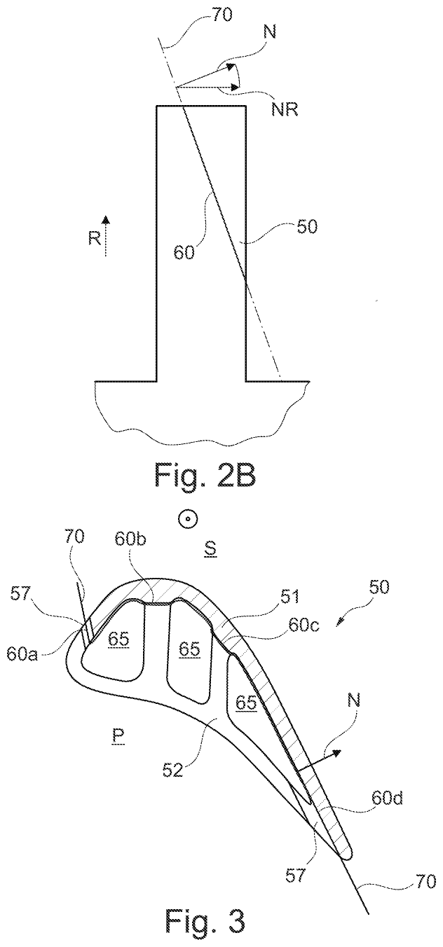

FIG. 2 shows a sectional view through a first embodiment of a blade component with two structural elements;

FIG. 2A shows a schematic side view with a vertical arrangement of the connecting face of two structural elements;

FIG. 2B shows a schematic side view with a sloping arrangement of the connecting face of two structural elements;

FIG. 3 shows a sectional view through a second embodiment of a blade component with two structural elements and cooling ducts;

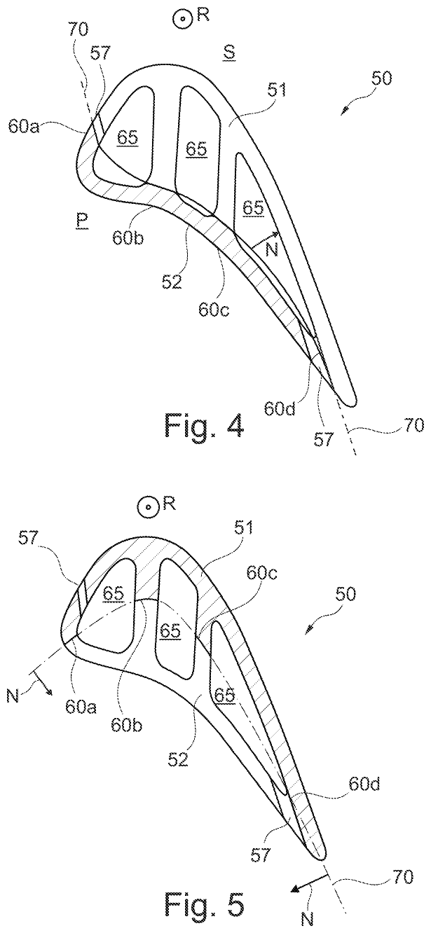

FIG. 4 shows a sectional view through a third embodiment of a blade component with two structural elements and cooling ducts;

FIG. 5 shows a sectional view through a fourth embodiment of a blade component with two structural elements and cooling ducts;

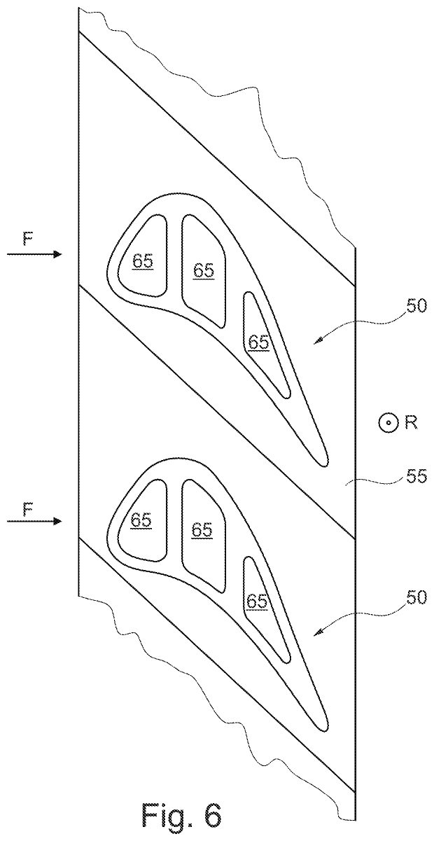

FIG. 6 shows a sectional view through two blade components with cooling ducts on a ring or disc component;

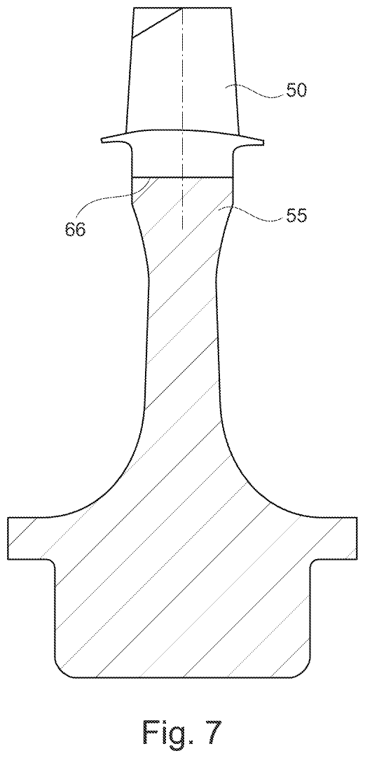

FIG. 7 shows a sectional view through a blade component and a disc component;

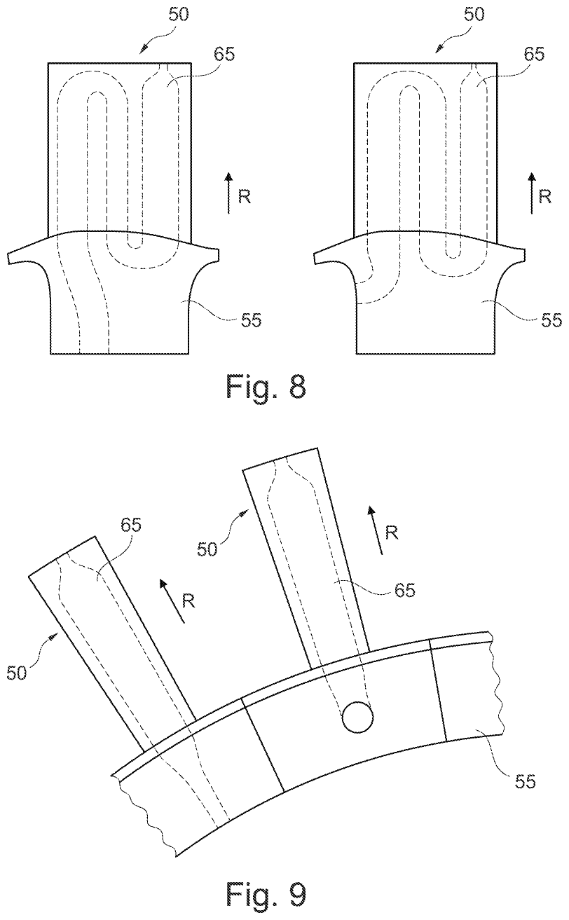

FIG. 8 shows an axial view of two blade components, each with a cooling duct, on a ring component;

FIG. 9 shows a sectional view through a blade component and a disc component.

FIG. 1 illustrates a gas turbine engine 10 having a main axis of rotation 9. The engine 10 comprises an air intake 12 and a fan 23 that generates two air flows: a core air flow A and a bypass air flow B. The gas turbine engine 10 comprises a core 11 that receives the core air flow A. When viewed in the order corresponding to the axial direction of flow, the core engine 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary gear box 30.

During operation, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before they are expelled through the nozzle 20 to provide a certain thrust. The high-pressure turbine 17 drives the high-pressure compressor 15 by way of a suitable connecting shaft 27. The fan 23 generally provides the major part of the thrust force. The epicyclic planetary gear box 30 is a reduction gear box.

The low-pressure turbine 19 (see FIG. 1) drives the shaft 26, which is coupled to a sun gear 28 of the epicyclic planetary gear box 30. Multiple planet gears, which are coupled to one another by a planet carrier, are situated radially to the outside of the sun gear and mesh therewith. The planet carrier guides the planet gears in such a way that they circulate synchronously around the sun gear, whilst enabling each planet gear to rotate about its own axis. The planet carrier is coupled via linkages to the fan 23 in order to drive its rotation about the engine axis 9. Radially to the outside of the planet gears and intermeshing therewith is an external gear or ring gear that is coupled via linkages to a stationary supporting structure 24.

It is noted that the terms “low-pressure turbine” and “low-pressure compressor” as used herein may be taken to mean the lowest-pressure turbine stage and lowest-pressure compressor stage (i.e. not including the fan 23) respectively, and/or the turbine and compressor stages that are connected together by the connecting shaft 26 with the lowest rotational speed in the engine (i.e. not including the gearbox output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 may be referred to as a first, or lowest-pressure, compression stage.

The compressors 14, 15 and the turbine 17, 19 in the embodiment depicted each have at least one stage in which the blades serve to convert flow energy into a rotational movement.

Embodiments of blade components 50 are described below for manufacturing of the blades which, after the end of production, may be used in this way in an axial compressor or axial turbine.

Here, blade components 50 are described which can be used in particular in gas turbine engines 10 for aircraft. Use of the blade components 50 is not however restricted to this application. Gas turbines with blades produced accordingly in the turbine and/or compressor stages may also be used in other vehicles or in ships. Also, such blades may be used in stationary gas turbines, e.g. in energy conversion.

FIG. 2 shows a sectional view through a blade component 50 which is used to produce one of the above-mentioned blades. The axial section plane of the view lies perpendicularly to the radial direction R of the gas turbine engine 10.

After production of the blade using the blade component 50, this is exposed to an axial flow from the left (flow direction F) so that the suction side S lies on the top of the blade and the pressure side P on the bottom.

The blade component 50 may in principle be part of a compressor or turbine stage of the gas turbine. The blade component 50 may in particular comprise only the blade itself or also be part of a larger component, e.g. a blisk.

The embodiment of the blade component 50 shown here is assembled from two structural elements 51, 52 which are each formed as solid bodies. The first structural element 51 on the outside comprises the suction side S, the second structural element 52 on the outside comprises the pressure side P.

If the blades are manufactured in a metal injection molding process, the two structural elements 51, 52 are formed as green parts which touch at a connecting face 60, i.e. the connecting face 60 lies in the interior of the assembled blade component 50. As clearly evident in further embodiments (e.g. FIG. 3), the connecting face 60 may also be divided into several parts.

In the embodiment shown, the one connecting face 60 lies on a spatially curved face 70. Here, the face 70 has only one curvature (i.e. it is constant in the radial direction R), wherein the normal vector N of the face 70 is oriented perpendicularly to the radial orientation R of the blade component 50. The radial orientation R relates to the orientation of the blade when assembled in the gas turbine.

This means that in this embodiment, the normal vector N of the face 70 lies in the section plane of FIG. 2. The curvature axis K of the face 70, which extends in the radial direction R, here lies on the pressure side P. In the embodiment illustrated, the face 70 has only one curvature at each point thereof.

It is however not necessary for the normal vector N of the face 70 to lie completely in a plane perpendicular to the radial direction R. This is explained in FIGS. 2A and 2B. FIG. 2A shows a side view of a blade component 50 which extends outward from a base in the radial direction R. The face 70, in which the connecting face 60 (one piece or multipiece) lies, is here formed as a face which divides the blade component 50 vertically. All normal vectors N (here three) stand perpendicularly to the radial extent R. This corresponds in principle to the arrangement illustrated in FIG. 2.

FIG. 2B shows the same blade component 50 as FIG. 2A. Here too, the face 70 is formed as a plane, which however intersects the blade component 50 at an angle. Thus the normal vector N also stands at an angle. However, here again, a component N_{R} stands perpendicularly to the radial extent.

In other embodiments, the face 70 in which the connecting face 60 (or its parts) lies may be more complex. Thus the face 70 may extend as a free-form spatial face, wherein this may at one point have two curvatures in different spatial directions, so that the blade component 50 may be formed from structural elements 51, 52 with highly complex form. In any case however, here again, the normal vector N (or at least a component N_{R}), at least for part of the face 70, is oriented perpendicularly to the radial orientation R of the blade component 50.

A blade component 50 assembled accordingly from green parts 51, 52 is connected by means of a connecting process, here sintering, as part of a metal injection molding process.

FIG. 3 shows a second embodiment of a blade component 50 which externally is shaped similarly to the embodiment in FIG. 2. The statements relating to FIG. 2 may therefore be applied accordingly to this embodiment.

However, three channels 65, through which cooling air may flow during operation, are arranged in the interior. Thus the internal structure of the blade component 50 is more complex than in the embodiment of FIG. 2.

The first structural element 51 comprises the suction side S and forms an outer edge of the blade component 50. The inside of the first structural element 51 is here formed substantially smooth.

The second structural element 51 comprises the pressure side P of the blade component 50 and two inner walls which delimit the cooling ducts 65 in the interior of the blade component 50.

Instead of a closed connecting face 60, as in the embodiment of FIG. 2, here the connecting face 60 is divided into four part regions 60a, 60b, 60c, 60d. The face 70 on which the four part regions 60a, 60b, 60c, 60d lie is accordingly more complex in form. Thus the curvature of the face 70 changes from the first part region 60a of the connecting face to the second part region 60b, and then the curvature direction again changes in the transition to the third part region 60c. As in the embodiment of FIG. 2, here too the normal vector N (for reasons of clarity, only one is shown) of the face 70 is arranged perpendicularly to the radial direction R.

Since the two structural elements 51, 52 are present separately as green parts which can then be sintered together, the structural elements 51, 52 themselves may be easily produced even if they have complex shapes. In addition, in this way, the cooling ducts 65 can easily be formed during assembly. The spatial orientation of the cooling duct 65 inside the blade components is illustrated in more detail in connection with FIGS. 8 and 9.

Furthermore, in the embodiment of FIG. 3, cooling openings 57 are provided which may also be created on production of the green parts. This avoids later creation thereof in the finished component.

The third embodiment according to FIG. 4 is a derivative of the second embodiment, so reference may be made to the corresponding description.

Here, the second structural element 52 comprises the pressure side P, while the first structural element 51 comprises the suction side S and the inner walls for forming the internal compartments for the cooling ducts. When the two structural elements 51, 52 are assembled, the same shape as in the second embodiment is achieved.

This face 70, on which the four part regions 60a, 60b, 60c, 60d of the connecting face lie, has two inflection points. However, here again, the curvature of the face in the radial direction R is constant.

In this embodiment, the cooling air openings 57 lie at least partially in the face 70. This means that each structural element 51, 52 comprises a part of the cooling air openings 57, wherein the complete cooling air opening 57 results when the structural elements 51, 52 are assembled.

The fourth embodiment (shown in FIG. 5) has a similar form of the face 70 for the connecting faces 60a, 60b, 60c, 60d as the first embodiment, i.e. the face 70 has only one curvature which is also constant over the radial direction R. As in the other embodiments, the normal vector N of the face lies perpendicularly to the radial direction R.

The fourth embodiment of the blade component 50 has three cooling ducts 65 which are formed in approximately equal parts by the inner walls of the structural elements 51, 52.

Here again, two cooling air openings 57 are provided.

The four embodiments shown so far each comprise two structural elements 51, 52. In principle, it is also possible to use more than two structural elements 51, 52 to form a blade component 50. Thus structural elements 51, 52 with particularly complex form may be produced in different processes, before then being connected together by sintering. It is also possible (similarly for example to FIG. 2B) that the face 70 slopes relative to the radial extent R.

The green parts of the structural elements 51, 52 may be made from the same materials. However, it is also possible to make the green parts of the structural elements 51, 52 from different materials.

Since, in operation, the blades are exposed to different mechanical and/or thermal loads are different points, the structural elements 51, 52 may be made of different materials at the points exposed to high loads than at the points exposed to lower loads. Thus a design appropriate for loading can be created in a metal injection molding process.

So far, in the production of the embodiments of the blade component 50, only the production of the blade itself from two structural elements 51, 52 has been described.

It is however also possible to connect the blade component 50 to a ring component or a disc component 55, which is formed as a green part of a metal injection molding process, in particular by sintering, so as to form a compressor or turbine stage.

In this way, compressor or turbine stages can be assembled from individual green parts which can be formed individually. Thus the basic structure of the disc component 55 is usually simpler than that of blades with complex curvature, which may also have an inner structure with cooling ducts 65 of complex form. Thus each of the parts 51, 52, 55 may be produced economically in order then to form a unitary part, a blisk, during sintering.

FIG. 6 shows a sectional view through two blade components 50, wherein the section plane is arranged perpendicularly to the radial direction R. The blade components each comprise cooling ducts 65, as in the embodiments of FIGS. 3 to 5.

The face 70 which separates the two structural elements 51, 52 is not shown here for reasons of clarity. In principle, any of the above-described embodiments may be used.

The two blade components 50 are arranged on a ring component or disc component 55 to which they may be sintered as described above. This is illustrated for example in FIG. 7 in a sectional view with a radial section plane.

A blade, which is connected to the disc component 55 by a connecting face 66, is arranged on the outer periphery. After sintering, a one-piece turbine stage or unitary compressor stage is obtained. As stated above, however, the one-piece stage may comprise different materials at different locations in order to counter loading in targeted fashion.

FIG. 8 shows two blade components 50 in a side view. The radial direction R here points upward.

The dotted lines illustrate a cooling duct 65 in the blade components. The cooling air enters at the lower end, i.e. at the disc component 55, and exits again through openings at the distal ends of the blade components 50. The cooling ducts 65 have two windings on their passage through the blade components 50. If this embodiment is cut as illustrated in FIGS. 2 to 5, three separate cooling ducts 65 will be seen, but a single cooling air stream can flow through these. FIG. 9 shows the arrangement from FIG. 8 in an axial view.

It is understood that the invention is not limited to the embodiments described above, and various modifications and improvements can be made without departing from the concepts described herein. Any of the features may be used separately or in combination with any other features, unless they are mutually exclusive, and the disclosure extends to and includes all combinations and subcombinations of one or more features that are described herein.

### LIST OF REFERENCE DESIGNATIONS

9 Main axis of rotation
10 Gas turbine engine
11 Core engine
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass channel
23 Fan
24 Stationary support structure
26 Shaft
27 Connecting shaft
30 Gear mechanism, planetary gear
A Core airflow
B Bypass airflow
50 Blade component
51 First structural element of blade component
52 Second structural element of blade component
55 Ring component, disc component
57 Cooling air opening
60 Connecting face
60a Part of connecting face
60b Part of connecting face
60c Part of connecting face
60d Part of connecting face
66 Cooling duct
66 Connecting face blade component/disc component
70 Spatial face
A Core air flow
B Bypass air flow
D Pressure side of blade component
F Contact flow direction
K Axis of curvature
N Normal vector of spatial face
N_{R} Radial component of normal vector
R Orientation of normal vector of face
S Suction side of blade component

1. A blade component of a compressor or turbine stage of a gas turbine, in particular of a gas turbine engine,
wherein
the blade component has at least two structural elements which can be connected together by means of a connection process, in particular sintering, and
the at least one connection face of the at least two structural elements lies on a face, wherein in particular the normal vector has, for at least a part of the face, a component perpendicular to the radial orientation of the blade component.

2. The blade component as claimed in claim 1, wherein the face has a curvature axis extending in the radial direction, the face is formed as a plane, or the face runs through the skeletal lines of the blade component.

3. The blade component as claimed in claim 1, wherein at least one cooling duct is arranged in its interior.

4. The blade component as claimed in claim 1, wherein at least two structural elements are configured as green parts of a metal injection molding process.

5. The blade component as claimed in claim 1, wherein at least two structural elements, in particular the at least two green parts, are made of different materials or comprise different materials.

6. The blade component as claimed in claim 4, wherein it can be connected to a ring component or a disc component, which is formed as a green part of a metal injection molding process, in particular by sintering, to form a compressor or turbine stage.

7. The blade component as claimed in claim 1, wherein one of the at least two structural elements comprises the suction side or the pressure side of the blade component.

8. The blade component as claimed in claim 1, characterized by at least one cooling opening which is formed in particular by assembly of the at least two structural elements.

9. A method for producing a blade component,
wherein
a) at least two structural elements and a disc component are provided, which
b) are connected by means of a connection process, in particular sintering, wherein the connection faces between the at least two structural elements lie on a face, wherein in particular the normal vector has, for at least a part of the face, a component-NB) perpendicular to the radial orientation of the blade component.

10. The method as claimed in claim 9, wherein at least two structural elements are connected, in particular sintered, to a ring component as a green part of a metal injection molding process, or to a disc component as a green part of a metal injection molding process.

11. The method as claimed in claim 9, wherein a sintering paste is used on sintering.

12. The method as claimed in claim 10, wherein the blade component and/or at least one of the structural elements are produced by means of a lost core in the metal injection molding process.

13. A gas turbine, in particular gas turbine engine, with at least one blade component as claimed in claim 1.

14. The gas turbine as claimed in claim 13, wherein it is designed as a stationary gas turbine, as a gas turbine for a ship, or as a gas turbine engine for an aircraft.
